(19) United States
(12) Patent Application Publication
(10) Pub. No.: US 2025/0327526 A1
(43) Pub. Date: Oct. 23, 2025

(54) VALVES FOR COOLING SYSTEMS OF MARINE DRIVES

(71) Applicant: Brunswick Corporation, Mettawa, IL (US)

(72) Inventors: Jacob D. Packianathan, Appleton, WI (US); Shashikumar Chinnahalli Hanumantharaya, Bangalore (IN)

(73) Assignee: Brunswick Corporation, Mettawa, IL (US)

(21) Appl. No.: 18/734,596

(22) Filed: Jun. 5, 2024

(30) Foreign Application Priority Data
Apr. 22, 2024 (IN) 202421031916

(51) Int. Cl. F16K 11/22; B63H 20/28; F28F 27/02

(52) U.S. Cl. CPC F16K 11/22; B63H 20/285; F28F 27/02

(57) ABSTRACT

A marine drive includes a cooling system configured to circulate a cooling fluid to cool a component of the marine drive or a marine vessel, the cooling system includes a first flow path along which the cooling fluid is supplied to the component and a second flow path along which the cooling fluid is returned from the component. A valve is operable to block the first flow path and the second flow path to thereby prevent the circulation of the cooling fluid along the first flow path and the second flow path.

### CROSS REFERENCE TO RELATED APPLICATION

This application claims priority to and the benefit of Indian Patent Application number 202421031916, filed Apr. 22, 2024, which is incorporated herein by reference in its entirety.

### FIELD

The present disclosure relates to marine drives, such as outboard motors, and specifically to valves for cooling systems of marine drives.

### BACKGROUND

U.S. Pat. No. 11,691,707 is incorporated herein by reference and discloses a system for draining a cooling system of a power generation system on a marine vessel that includes a pump in fluid communication with the cooling system, the pump actively removing cooling water from the cooling system. An outlet drain discharges the cooling water. A controller starts the pump in response to an operator command to stop a prime mover of the marine power generation system and/or a speed of the prime mover being below a threshold speed.

### SUMMARY

This Summary is provided to introduce a selection of concepts that are further described below in the Detailed Description. This Summary is not intended to identify key or essential features of the claimed subject matter, nor is it intended to be used as an aid in limiting the scope of the claimed subject matter.

In certain independent examples, a marine drive includes a cooling system configured to circulate a cooling fluid to cool a component of the marine drive or a marine vessel, the cooling system includes a first flow path along which the cooling fluid is supplied to the component and a second flow path along which the cooling fluid is returned from the component. A valve is operable to block the first flow path and the second flow path to thereby prevent the circulation of the cooling fluid along the first flow path and the second flow path.

Optionally, the valve selectively blocks the first flow path and the second flow path to thereby isolate the component. Optionally, the valve is operable into an open position in which the valve is configured to permit the cooling fluid to be circulated along the first flow path and the second flow path. Optionally, the valve is operable into a closed position in which the valve is configured to block the first flow path and the second flow path such that the cooling fluid does not circulate through the first flow path and the second flow path. Optionally, the valve defines a first passageway through which the first flow path extends and a second passageway through which the second flow path extends, and the second passageway is independent of the first passageway. Optionally, the valve includes a first plunger selectively movable into the first flow path and a second plunger selectively movable into the second flow path to thereby prevent the circulation of the cooling fluid along the first flow path and the second flow path. Optionally, the valve includes a bracket coupled to the first plunger and the second plunger such that the first plunger, the second plunger, and the bracket are selectively moveable together. Optionally, the bracket, the first plunger, and the second plunger are movable together into an extended position such that the cooling fluid can be circulated along the first flow path and the second flow path and the bracket, the first plunger, and the second plunger are movable together into a retracted position in which the first plunger and the second plunger prevent the circulation of the cooling fluid along the first flow path and the second flow path. The valve further includes a body to which the bracket is selectively coupled to thereby lock the bracket, the first plunger, and the second plunger in the extended position or the retracted position. Optionally, the valve includes a flange with a first hole and a second hole and the bracket includes an arm with an arm hole. When the bracket is moved into a retracted position, the arm hole aligns with the second hole such that a fastener can be inserted through the arm hole and the second hole to lock the bracket in the retracted position. When the bracket is moved into an extended position, the arm hole aligns with the first hole such that the fastener can be inserted through the arm hole and the first hole to lock the bracket in the extended position. Optionally, the valve axially extends between a first end and a second end, and the first plunger and the second plunger are axially moved into the first flow path and the second flow path to prevent the circulation of the cooling fluid along the first flow path and the second flow path. Optionally, the valve includes a drain configured to permit draining of the cooling fluid from the first flow path or the second flow path. Optionally, the valve defines a first passageway through which the first flow path extends and a second passageway through which the second flow path extends and the drain is a first drain configured to permit draining of the cooling fluid from the first passageway. The valve further includes a second drain configured to permit draining of the cooling fluid from the second passageway. Optionally, the valve includes a first inlet and a first outlet through which the first flow path extends and a second inlet and a second outlet through which the second flow path extends. The first inlet and the second outlet extend parallel to a first axis, and the second inlet and the first outlet extend parallel to a second axis. The second axis is perpendicular to the first axis.

In certain independent examples, a valve includes a first passageway extending between a first inlet and a first outlet. The first inlet is configured to receive a cooling fluid from the marine drive such that the cooling fluid can be conveyed through the first passageway and dispensed via the first outlet to a component of the marine drive or a marine vessel. A second passageway extends between a second inlet and a second outlet, and the second inlet is configured to receive the cooling fluid from the component of the marine drive or the marine vessel such that the cooling fluid can be conveyed through the second passageway and dispensed from via the second outlet. A first plunger is selectively moveable to block the first passageway and a second plunger is selectively moveable to block the second passageway to thereby prevent circulation of the cooling fluid through the first passageway and the second passageway.

Optionally, the second passageway is independent from the first passageway. Optionally, the first inlet and the second outlet extend parallel to a first axis and the second inlet and the first outlet extend parallel to a second axis. The second axis is perpendicular to the first axis. Optionally, a first drain is configured to permit draining of the cooling fluid from the first passageway and a second drain configured to permit draining of the cooling fluid from the second passageway. The first drain and the second drain extend parallel to the second axis in a first direction, and the first outlet and the second inlet extend in an opposite second direction along the second axis. Optionally, a first drain is configured to permit draining of the cooling fluid from the first passageway and a second drain is configured to permit draining of the cooling fluid from the second passageway. Optionally, a bracket is coupled to the first plunger and the second plunger such that the bracket, the first plunger, and the second plunger are movable together. Optionally, a track is configured to guide movement of the bracket.

Various other features, objects, and advantages will be made apparent from the following description taken together with the drawings.

### BRIEF DESCRIPTION OF THE DRAWINGS

The present disclosure is described with reference to the following Figures. The same numbers are used throughout the Figures to reference like features and like components.

FIG. 1 is a side view of an example marine drive according to the present disclosure.

FIG. 2 is a side view of the marine drive of FIG. 1 with cowling removed.

FIG. 3 is a partial perspective view of the marine drive of FIG. 2.

FIG. 4 is a perspective view of an example valve according to the present disclosure in an open position.

FIG. 5 is a cross-sectional view of the valve of FIG. 4 along line 5-5 on FIG. 4.

FIG. 6 is a cross-sectional view of the valve of FIG. 4 along line 6-6 on FIG. 4.

FIG. 7 is a cross-sectional view of the valve of FIG. 4 along line 7-7 on FIG. 4.

FIG. 8 is a perspective view of the valve of FIG. 4 in a closed position.

FIG. 9 is a cross-sectional view of the valve of FIG. 4 along line 9-9 on FIG. 4.

FIG. 10 is a cross-sectional view of the valve of FIG. 4 along line 10-10 on FIG. 4.

FIG. 11 is a cross-sectional view of the valve of FIG. 4 along line 11-11 on FIG. 4.

### DETAILED DISCLOSURE

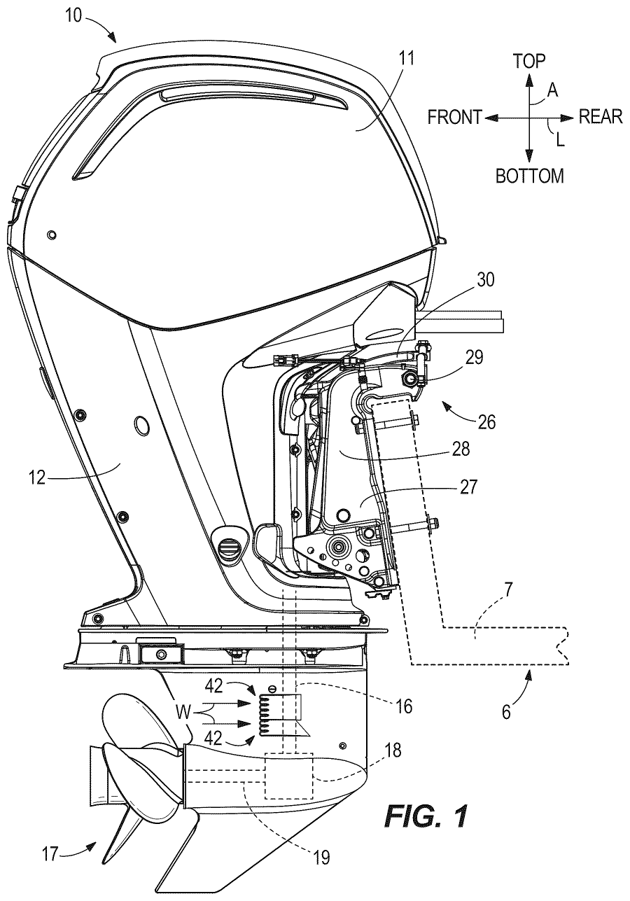

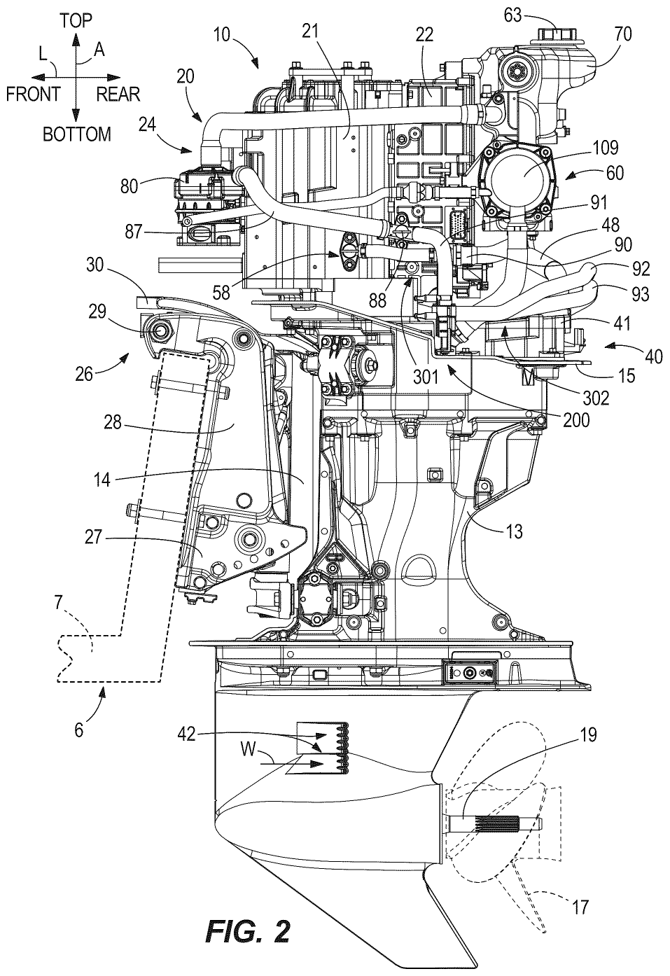

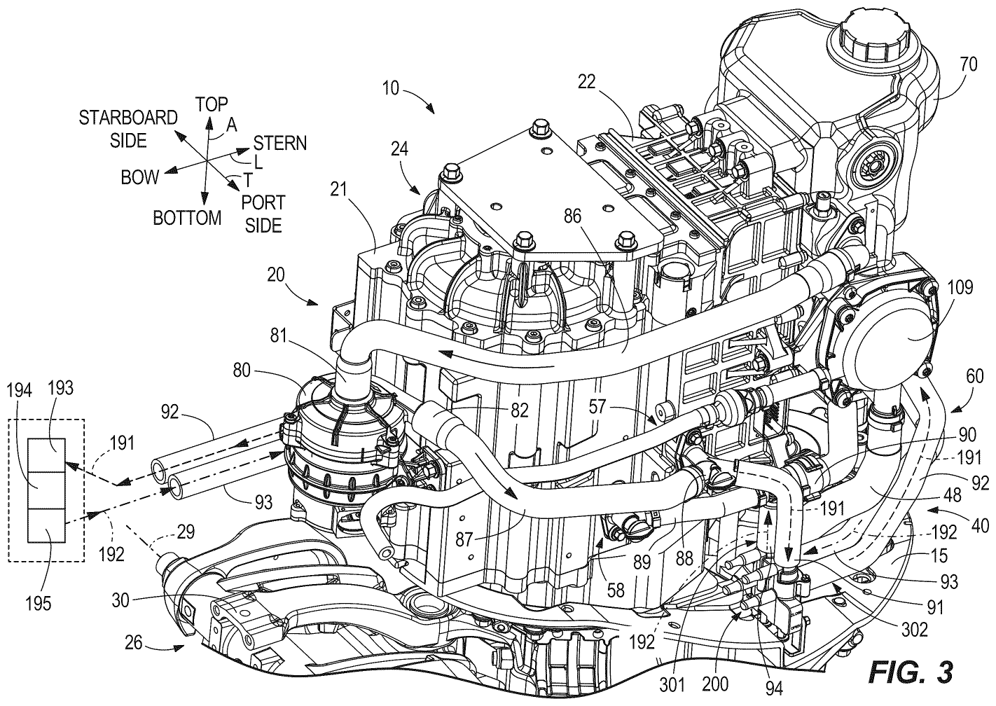

FIGS. 1-3 depict a marine drive 10 for propelling a marine vessel 6 in water. The example marine drive 10 illustrated in FIGS. 1-3 is an outboard motor with a top cowl 11 and a lower cowl 12 that covers a midsection 13 (FIG. 2). Note that FIGS. 2-3 depict the marine drive without the cowls 11, 12. The illustrated type of marine drive is not necessarily limiting and in many respects, the present disclosure is also applicable to other types of marine drives, such as stern drives, pod drives, and/or the like. In the illustrated example, the midsection 13 has a driveshaft housing 14 suspended from an adapter plate 15. The driveshaft housing 14 houses the driveshaft 16 (see dashed lines on FIG. 1) and other usual components of an outboard motor, such as exhaust components, cooling systems components, electrical components, and/or the like. Note that various other components normally associated with outboard motors may also be provided with or coupled to the midsection 13. The marine drive 10 extends from a top to a bottom in an axial direction (see example axis A), from a port side to a starboard side in a lateral direction (see example lateral axis T on FIG. 3) which is perpendicular to the axial direction, and from a front side to a rear side in a longitudinal direction (see example longitudinal L axis) which is perpendicular to the axial direction and perpendicular to the lateral direction.

A conventional transom bracket assembly 26 is configured to mount the marine drive 10 on the marine vessel 6. The transom bracket assembly 26 includes a transom bracket 27 which is fixed to the transom 7 on the marine vessel 6 and a swivel bracket 28 which is pivotably coupled to the transom bracket 27. The swivel bracket 28 is also coupled to the midsection 13 for example via fasteners and/or one or more shock-absorbing mounts, as is known in the art. One or more trim actuators (not depicted; e.g., hydraulic cylinders) are provided for trimming the marine drive 10 about a trim axis 29 relative to the transom bracket assembly 26. Specifically, the trim actuators are configured to pivot the swivel bracket 28 about the trim axis 29 and thus the marine drive 10 is pivoted relative to the transom 7 of the marine vessel 6.

A steering arm 30 extends from the midsection 13 and is configured to be pivoted upon actuation of a steering actuator (not depicted) which is configured to steer the marine drive 10 about a steering axis (not depicted).

A powerhead 20, including for example a gas engine and/or an electric motor, is coupled to the adapter plate 15. The depicted powerhead 20 includes an electric motor 21 configured to rotate the driveshaft. An inverter 22 is configured to provide electrical power to the motor 21. The inverter 22 receives the electrical power from a power supply (e.g., rechargeable batteries on the marine vessel 6 via an electrical cable (not depicted). The top cowl 11 encloses the powerhead 20 in a powerhead compartment 24 located above the adapter plate 15. The top cowl 11 can be opened or removed from the marine drive 10 to provide access to the powerhead compartment 24 and the powerhead 20 from above the marine drive 10.

A propulsor 17 (e.g., one or more propellers, impellers, and/or the like) is positioned at the bottom of the driveshaft housing 14 and is coupled to the driveshaft 16 via a gearset 18 (see dashed lines on FIG. 1; e.g., a beveled gearset assembly). In operation, the rotation of the driveshaft 16 causes the gearset 18 and a propulsor shaft 19 to rotate such that the propulsor propels the marine vessel 6 in the water.

The motor 21, the inverter 22, and other components of the marine drive 10 are cooled by one or more cooling systems 40, 60. In certain examples, one of the cooling systems is an open loop, first cooling system 40. This system 40 includes a first pump 41 configured to circulate a first cooling fluid through the marine drive 10. The first cooling fluid can be any suitable fluid, and in the example depicted in FIGS. 1-2, the first cooling fluid is water from the body of water in which the marine vessel 6 and the marine drive 10 are located.

The first pump 41 draws the first cooling fluid (see arrows W) from the relatively lower temperature water in the body of the water via one or more water inlets 42 in the lower cowl 12 (see also FIG. 1). The first pump 41 then pumps the first cooling fluid through water conduits 48 to a heat exchanger 109 in which the first cooling fluid absorbs heat/thermal energy from the second cooling fluid, which is also in the heat exchanger 109 (note that the first cooling fluid is fluidly separated from the second cooling fluid). As such, the temperature of the first cooling fluid exiting the heat exchanger 109 is relatively higher than the temperature of the first cooling fluid entering the heat exchanger 109.

After exiting the heat exchanger 109, the first cooling fluid passes through one or more conduits (not depicted) and/or the adapter plate 15 (FIG. 2) and flows back into the body of water. In certain examples, the relatively higher temperature first cooling fluid (e.g., water) exits the marine drive 10 via the propulsor 17 (e.g., the propeller hub). Note that in certain examples, the first cooling system 40 is configured to pump the first cooling fluid along an open loop, first cooling circuit, which may pass through one or more components such as the first pump 41, a plurality of conduits and/or conduit connectors noted above, and/or the heat exchanger 109.

The marine drive 10 also includes a closed loop, second cooling system 60 having a reservoir 70 that contains the second cooling fluid and a second pump 80 configured to pump the second cooling fluid through the heat exchanger 109. A pump inlet 81 receives the second cooling fluid passing through a first inlet conduit 86 from the heat exchanger 109.

The second pump 80 pumps the second cooling fluid via a pump outlet 82 to a first outlet conduit 87 (FIG. 3) which is coupled to conduit connector 88 (e.g., y-shaped connector). The conduit connector 88 is configured to direct the second cooling fluid to or through a component of the marine drive 10, such as to an inverter inlet 57 into the inverter 22 and/or through the motor 21. The second cooling fluid is configured to cool the one or more components of the marine drive 10. In one example, the second cooling fluid directed through the inverter inlet 57 passes through internal channels (not depicted) in the inverter 22 and/or the motor 21 such that thermal energy from the inverter 22 and/or the motor 21 transfers to the second cooling fluid. The warmed second cooling fluid exits the inverter 22 and/or the motor 21 via a motor outlet 58 (FIG. 3) to is conveyed via a second outlet conduit 89 (FIG. 3).

The conduit connector 88 noted above is also configured to direct the second cooling fluid along a first flow path 191 (see evenly dashed lines that partially depict the first flow path 191) to one or more other components of the marine drive 10 and/or the marine vessel 6 such that the second cooling fluid is supplied to and cools the one or more of the other components. The components that may be cooled can include another component of the marine drive 10, such as a power distribution unit (not depicted) in the powerhead 20, and/or a component or device on the marine vessel 6 (e.g., a component or device separated from the marine drive 10) such as a power storage unit 193 (e.g., rechargeable battery), power distribution unit (PDU) 194, another heat exchanger 195, and/or the like. An example power storage unit 193, PDU 194, and heat exchanger 195 are schematically depicted on FIG. 3.

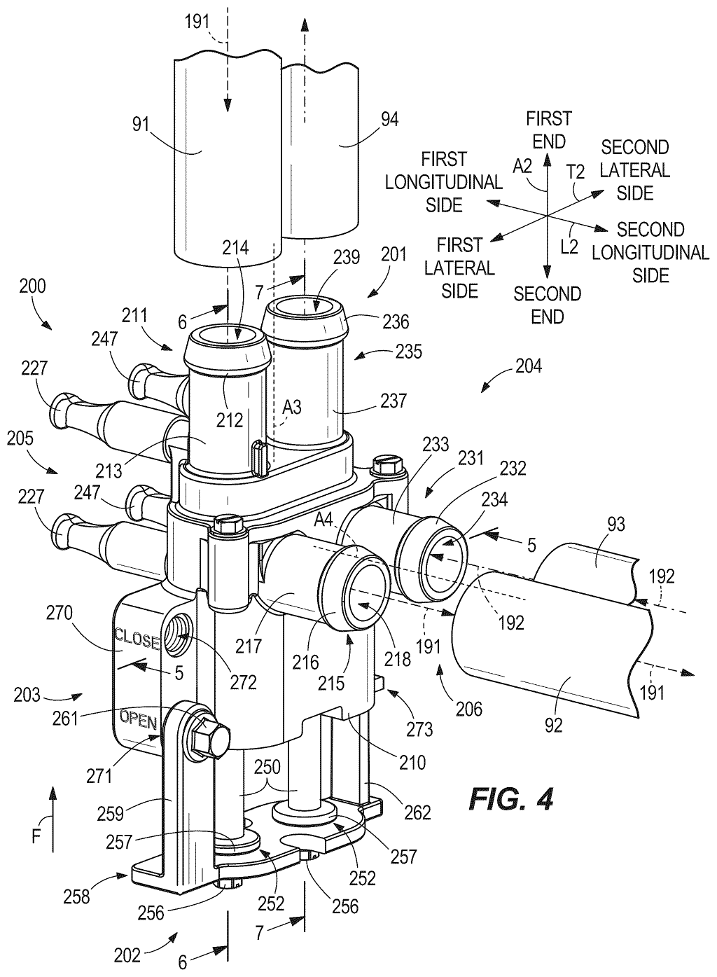

The conduit connector 88 is coupled to a first conduit 91, and the first conduit 91 is coupled to a valve 200 according to the present disclosure (described further herein). When the valve 200 is in the open position (FIGS. 4-7), the second cooling fluid can be conveyed or pumped through the valve 200 to a second conduit 92. In certain examples, the second conduit 92 extends around the powerhead 20 and through a rigging elbow 97 into the marine vessel 6 where the second cooling fluid cools one or more components on the marine vessel 6. In other examples, the second conduit 92 extends to another component of the marine drive 10 where the second cooling fluid cools the other component of the marine drive. The first flow path 191 extends from the conduit connector 88 through the first conduit 91, the valve 200, and the second conduit 92 to the component to be cooled by the second cooling fluid.

The warmed, second cooling fluid is pumped from the component(s) cooled by the second cooling fluid (e.g., the power storage unit 193, power distribution unit (PDU) 194, and/or the heat exchanger 195 on the marine vessel 6 or another component of the marine drive 10) along a second flow path 192 (see dash-dot lines that partially depict the second flow path 192) which extends from the component(s) cooled by the second cooling fluid back through a third conduit 93 (which exemplarily passes through the rigging elbow 97 and extends around the powerhead 20), the valve 200, and a fourth conduit 94 back to a second conduit connector 90 (described herein).

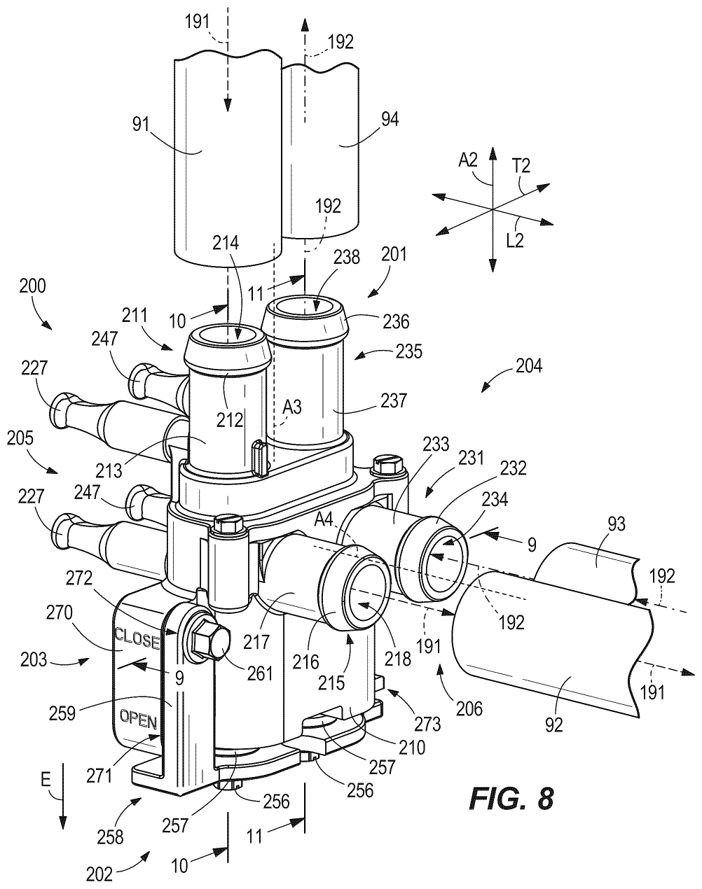

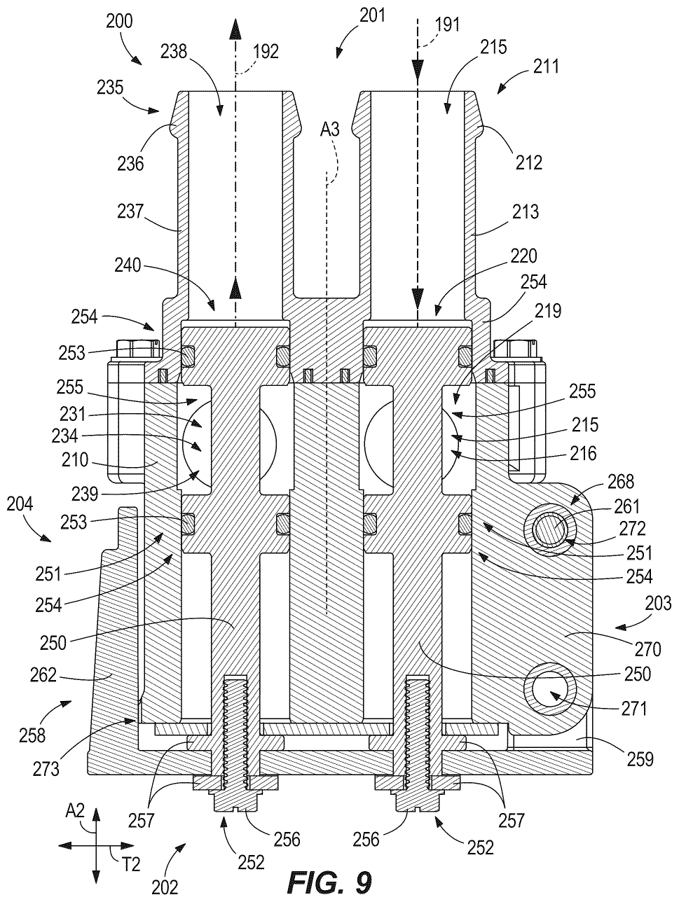

The third conduit 93 is coupled to the valve 200, and when the valve 200 is in the open position, the second cooling fluid can be conveyed or pumped through the third conduit 93, through the valve 200, and further through the fourth conduit 94. Accordingly, when the valve 200 is in the open position (FIGS. 4-7), the valve 200 permits flow and circulation of the second cooling fluid to the component along the first flow path 191 and the second flow path 192 and when the valve 200 is in the closed position (FIG. 8-11), the valve 200 blocks or prevents flow and circulation of the second cooling fluid through the first flow path 191 and the second flow path 192.

The fourth conduit 94 is coupled to the valve 200 and further coupled to a second conduit connector 90. The second conduit connector 90 is configured to receive the warmed second cooling fluid from the second outlet conduit 89 and the fourth conduit 94 and further direct the warmed second cooling fluid to the heat exchanger 109. The heat exchanger 109 is configured to facilitate heat transfer from the warmed second cooling fluid to the relatively cooler first cooling fluid that is pumped through the open loop, first cooling circuit (as described above). Note that in certain examples, the second cooling system 60 is configured to pump the second cooling fluid along a closed loop, second cooling circuit, which may pass through one or more components such as the second pump 80, a plurality of conduits and/or conduit connectors noted above, the valve 200, and/or the heat exchanger 109.

The present inventors developed the example valves 200 of the present disclosure (described in greater detail hereinbelow) to reduce or eliminate several problems identified by the present inventors relative to conventional marine drives. For example, the present inventors recognized that during rigging and/or servicing activities for conventional marine drives, connecting and disconnecting conduits which are coupled between the marine drive and components on the marine vessel can lead to inadvertent spillage of the second cooling fluid. The present inventor also recognized that it may be necessary during servicing and/or installation of the marine drive to the marine vessel to drain the second cooling fluid from the cooling system which may be difficult to complete on conventional marine drives. The present inventors also recognized that the conventional valves, quick-connect devices, and the like, which may be utilized on conventional marine drives for providing disconnect points between one or more conduits, can have significant restrictions to the flow of the second cooling fluid and create space constraints on the marine drive 10 (e.g., conventional devices occupy a large amount of space in the powerhead compartment and/or conflict with the cowling).

Turning now to FIG. 4-11, an example valve 200 according to the present disclosure is depicted. The valve 200 extends from a first end 201 to a second end 202 in an axial direction (see example axis A2), from a first lateral side 203 and a second lateral side 204 in a lateral direction (see example lateral axis T2 in FIG. 3) which is perpendicular to the axial direction, and from a first longitudinal side 205 to a second longitudinal side 206 in a longitudinal direction (see example longitudinal L2 axis) which is perpendicular to the axial direction and perpendicular to the lateral direction. Note the directions and example axes noted above with respect to the valve 200 can align with or be different than the directions and example axes noted above with respect to the marine drive 10. It should be understood that the orientation of the valve 200 relative components of the marine drive 10 can vary, and FIG. 3 depicts an example valve 200 generally having the first end 201 of the valve 200 oriented toward the top of the marine drive 10. However, depending on the configuration of the marine drive 10, the first end 201 may be oriented in other directions, such as toward the stern of the marine drive 10.

Note while the valve 200 depicted in FIGS. 4-11 is described hereinbelow with respect to the example axes, directions, ends 201, 202, and the sides 203-206, such example is not-limiting, and the present disclosure includes other example valves having the axes, directions, end 201, 202, the sides 203-206, and/or components or features (described in greater detail herein below) in different locations, reversed, or mirrored relative than to the example depicted in FIG. 4. For instance, in another example valve not depicted in FIGS. 4-11, the drains 224, 244 extend from a second longitudinal side 206 and a first outlet 215 and a second inlet extends from the first longitudinal side 205.

Referring specifically to FIGS. 4-7, the valve 200 is depicted in the open position such that the second cooling fluid can be pumped along the flow paths 191, 192 noted above.

The valve 200 includes a body 210 and a first inlet 211. The first inlet 211 is configured to couple to the first conduit 91, and the first inlet 211 axially extends from the first end 201 of the valve 200. The first inlet 211 includes an annular, radially extending barb 212 extending from a sidewall 213 that is configured to engage the first conduit 91. The sidewall 213 at least partially defines an axially extending bore 214. The first inlet 211 is configured to receive the second cooling fluid from the first conduit 91.

The valve 200 includes a first outlet 215 that is configured to couple to the second conduit 92. The first outlet 215 longitudinally extends from the second longitudinal side 206 of the valve 200, and the first outlet 215 includes an annular, radially extending barb 216 extending from a sidewall 217 that is configured to engage the second conduit 92. The sidewall 217 at least partially defines a longitudinally extending bore 218.

The valve 200 defines a first channel 219 that extends between the bores 214, 218. The bores 214, 218 and the first channel 219 collectively define a first passageway 220 through the valve 200. The second cooling fluid is received by the first inlet 211 and pumped through the passageway 220 to the first outlet 215. The first outlet 215 is configured to dispense the second cooling fluid to the second conduit 92. Note that the first flow path 191 extends through the first inlet 211, the first passageway 220, and the first outlet 215.

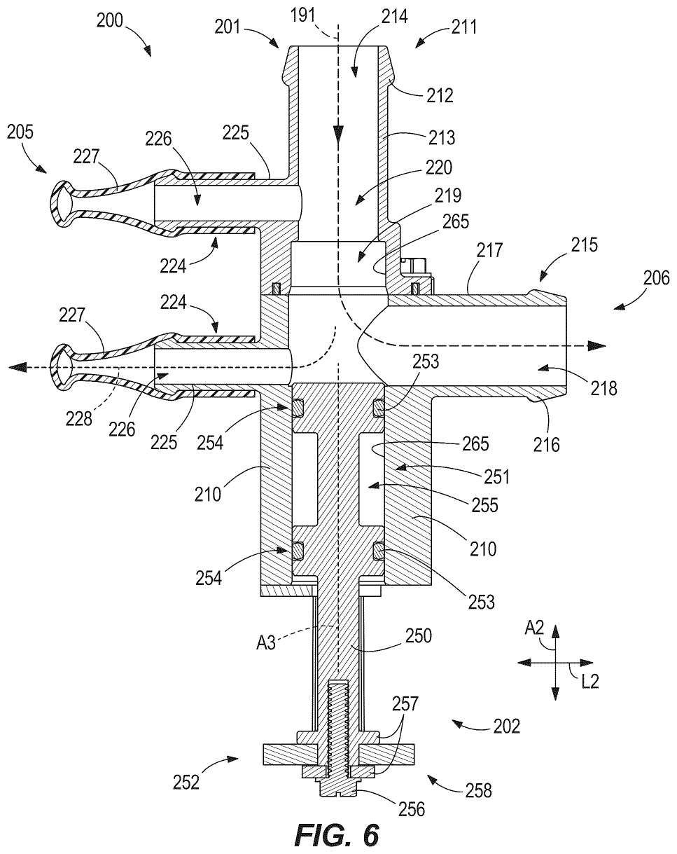

One or more first drains 224 are coupled to the body 210 and are configured to permit draining of the second cooling fluid from the valve 200. Each first drain 224 includes a sidewall 225 that at least partially defines a longitudinally extending drain bore 226 which is in fluid communication with the first passageway 220. In the example depicted in FIGS. 4-7, the first drains 224 longitudinally extend from the first longitudinal side 205 of the valve 200. In certain examples, the first drains 224 extend parallel to the second axis A4. A removable drain plug or cover 227 is coupled to each of the first drains 224 to thereby prevent the second cooling fluid from inadvertently dispensing from the first drain 224. The drain cover 227 is decoupled from the first drain 224 such that the second cooling fluid can be drained or dispensed from the first drain 224. See for example drain flow path (depicted as dashed line 228) when the drain cover 227 is removed thereby permitting the second cooling fluid to drain from the first passageway 220 via one of the first drains 224 (note that drain covers 227 are depicted coupled to the first drains 224 in FIG. 6).

The valve 200 further includes a second inlet 231. The second inlet 231 is configured to couple to the third conduit 93, and the second inlet 231 longitudinally extends from the second longitudinal side 206 of the valve 200. The second inlet 231 includes an annular, radially extending barb 232 extending from a sidewall 233 that is configured to engage the third conduit 93. The sidewall 233 at least partially defines a longitudinally extending bore 214. In certain examples, the second inlet 231 extends parallel to the first outlet 215. In certain examples, the second inlet 231 and the first outlet 215 extend parallel to a second axis A4 that extends perpendicular to a first axis A3 (see FIG. 4).

The valve 200 includes a second outlet 235 that is configured to couple to the fourth conduit 94. The second outlet 235 axially extends from the first end 201 of the valve 200, and the second outlet 235 includes an annular, radially extending barb 236 extending from a sidewall 237 that is configured to engage the fourth conduit 94. The sidewall 237 at least partially defines a longitudinally extending bore 238. In certain examples, the second outlet 235 extends parallel to the first inlet 211. In certain examples, the second outlet 235 and the first inlet 211 extend parallel to the first axis A3 that extends perpendicular to the second axis A4 (see FIG. 4).

The valve 200 defines a second channel 239 that extends between the bores 234, 238. The bores 234, 238 and the second channel 239 collectively define a second passageway 240 through the valve 200. The second cooling fluid is received by the second inlet 231 is configured to receive the second cooling fluid from the third conduit 93. The second cooling fluid and plumped through the passageway 240 to the second outlet 235. The second outlet 235 is configured to dispense the second cooling fluid to the fourth conduit 94, and the second cooling fluid is further pumped to the heat exchanger 109 (FIG. 3), as described above. Note that the second flow path 192 extends through the second inlet 231, the second passageway 240, and the second outlet 235. The second passageway 240 is independent from the first passageway 220 such that the second flow path 192 extending through the valve 200 is separated from the first flow path 191 extending through the valve 200.

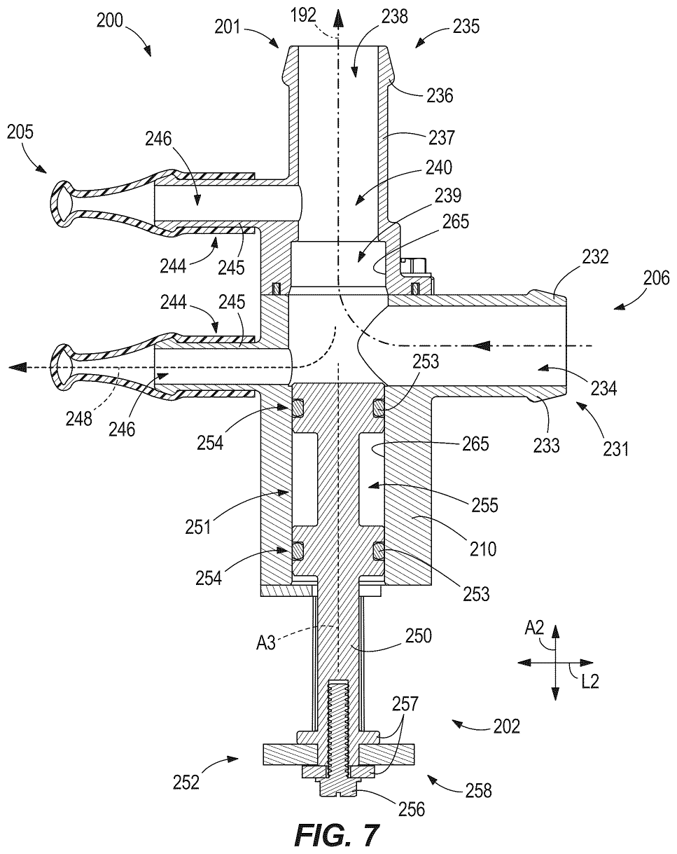

One or more second drains 244 are coupled to the body 210 and are configured to permit draining of the second cooling fluid from the valve 200. Each drain 244 includes a sidewall 245 that at least partially defines a longitudinally extending drain bore 246 which is in fluid communication with the second passageway 240. In the example depicted in FIG. 7, the second drains 244 longitudinally extend from the first longitudinal side 205 of the valve 200 and generally extend parallel with the first drains 224 (see FIG. 4). In certain examples, the second drains 244 extend parallel to the second axis A4. In certain examples, the first drains 224 and the second drains 244 extend in a first direction along the second axis A4 and the first outlet 215 and the second inlet 231 extend in an opposite second direction along the second axis A4. A removable drain plug or cover 247 is coupled to each of the second drain plugs 244 to thereby prevent the second cooling fluid from inadvertently dispensing from the second drain 244. The drain cover 247 is decoupled from the second drain 244 such that the second cooling fluid can be drained or dispensed from the second drain 244. See for example drain flow paths (depicted as dashed lines 248) when the drain cover 247 is removed thereby permitting the second cooling fluid to drain from the second passageway 240 via one of the second drains 244 (note that drain covers 247 are depicted coupled to the first drains 244 in FIG. 7).

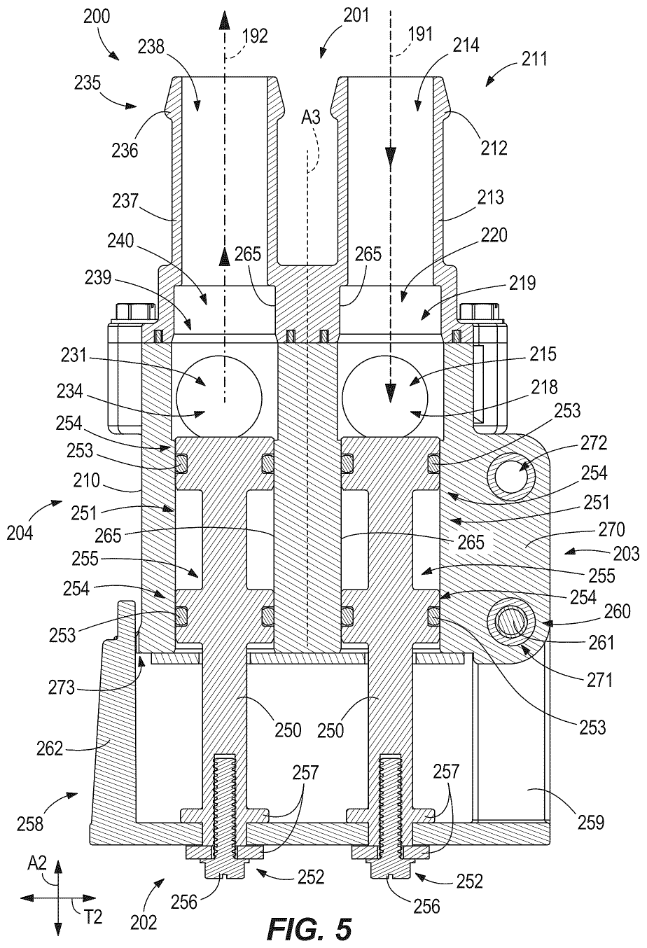

The valve 200 includes a pair of plungers 250 (e.g., a first plunger and a second plunger) that are configured to selectively block the second cooling fluid from being circulated or pumped through the valve 200. One of the plungers 250 is located in the first channel 219 and the other plunger 250 is located in the second channel 219. When the valve 200 is in the open position (FIGS. 4-7), the plungers 250 do not prevent the flow or circulation of the second cooling fluid along the first flow path 191 or the second flow path 192. In certain examples, the plungers 250 can be axially reciprocated along axes that are parallel to the first axis A3. In certain examples, the plungers 250 are axially moved into a first direction (see arrow G on FIG. 5) toward the first end 201 to

Each plunger 250 includes a first plunger end 251 received in one of the channels 219, 239 and a second plunger end 252 which axially extends from the second end 202 of the valve 200. The first plunger end 251 includes a pair of gaskets 253 which are configured to engage the interior surface 265 of the body 210 such that fluid-tight seals are formed between the gaskets 253 and the interior surface 265. As such, the second cooling fluid does not flow along the plungers 250 in a direction toward the second plunger ends 252. The first plunger end 251 also includes a pair of first plunger sections 254 and a second plunger section 255 positioned between the first plunger sections 254. The first plunger sections 254 have a first diameter that is larger than a second diameter of the second plunger section 255 (these plunger sections 254, 255 are described in greater detail therein below).

The second plunger ends 252 are each coupled to a bracket 258 with one or more fasteners 256 (e.g., screws, bolts) such that the bracket 258 and the pair of plungers 250 are moveable together. In certain examples, the second plunger ends 252 include radially extending flanges 257 between which the bracket 258 is received.

The bracket includes an arm 259 that axially extends in a direction from the second end 202 to the first end 201 of the valve 200. The arm 259 defines an arm hole 260 through which a fastener 261 (e.g., bolt, screw) extends to secure the arm 259 relative to the body 210 (described in greater detail herein). The bracket 258 also includes a leg 262 that also axially extends in a direction from the second end 202 to the first end 201 of the valve 200 and is received into an axially extending track 273 on the body 210 (described in greater detail herein below).

A flange 270 extends from the first lateral side 203 of the valve 200 and the track 273 is located along the second lateral side 204 of the valve 200. In certain examples, the positioning of the flange 270 and the track 273 may be reversed or switched (e.g., the flange 270 extends from the second lateral side 204 and the track 273 is located along the first lateral side 203) depending on the specific application of the valve 200 to thereby make the fastener 261 and the flange 270 more accessible to the operator of the valve 200. In one example, the track 273 includes a groove defined in the body 210 and the arm 259 has a tab or fin slidably received into the track 273.

The body 210 includes a flange 270 in which a first hole 271 and a second hole 272 are defined. The holes 271, 272 are selectively configured to receive the fastener 261 to thereby lock the bracket 258 and the plungers 250 in an extended position (FIG. 4-7) or a retracted position (FIG. 8-11). As depicted in FIGS. 4-7, the fastener 261 is in the first hole 271 and extends through the arm hole 260 thereby locking the bracket 258 and the plungers 250 in the extended position such that the plungers 250 cannot axially move. The leg 262 is in the track 273. In another example, the valve 200 has a flange 270 located on both lateral sides 203, 204 such that the bracket 258 can be attached to valve 200 in reversed orientations.

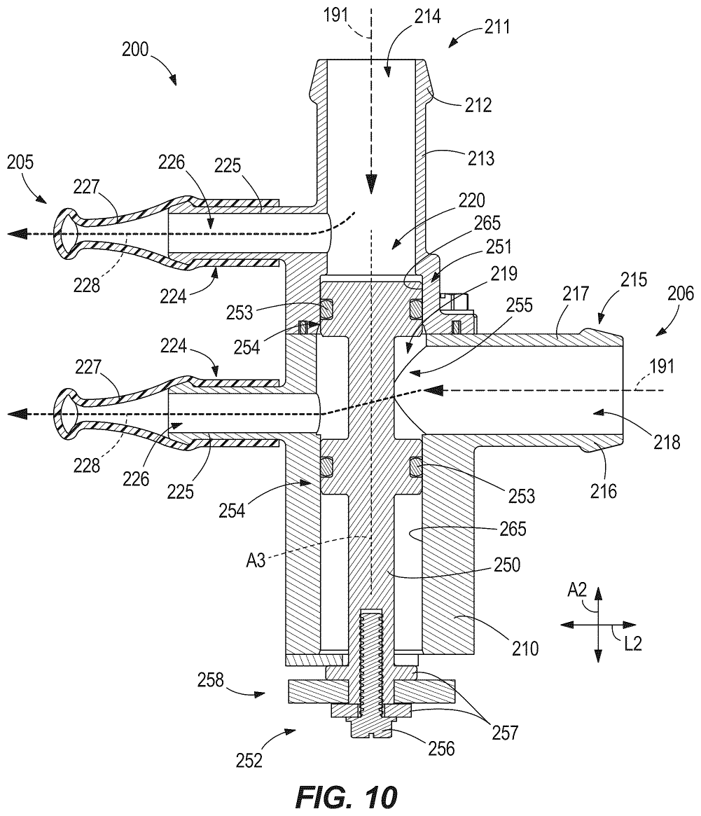

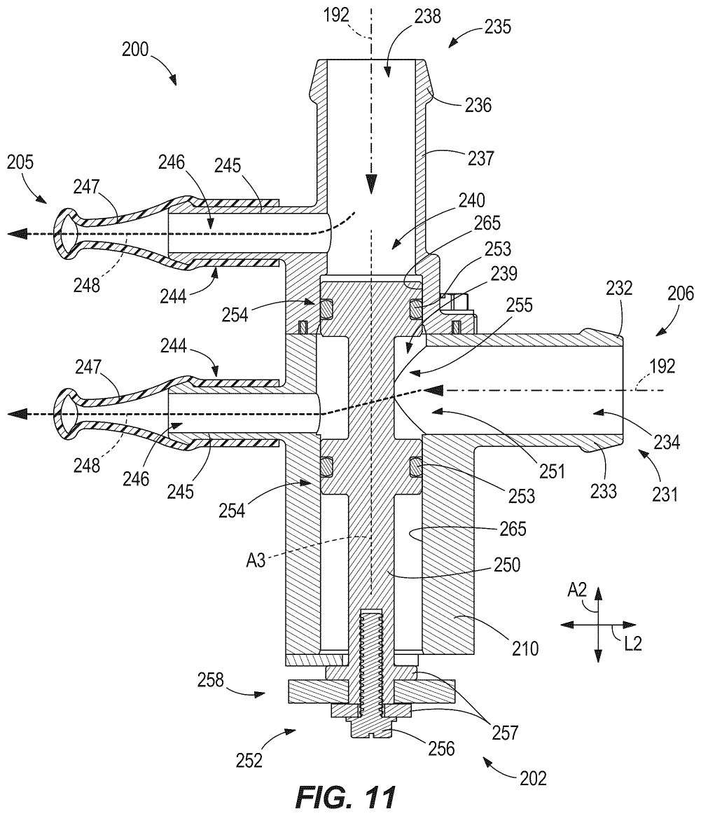

Turning now to FIGS. 8-11, the valve 200 is depicted in the closed position and the bracket 258 and the plungers 250 are in the retracted position such that the second cooling fluid does not flow or circulate along the first flow path 191 and the second flow path 192. FIGS. 10 and 11 depict each flow path 191, 192 broken or separated to thereby depict that the second cooling fluid cannot be circulated through the valve 200. In certain examples, the valve 200 fluidly separated a first section 301 (see FIGS. 2-3; e.g., a marine drive section) of the second cooling system 60 from a second section 302 (see FIGS. 2-3; e.g., a boat section) of the second cooling system 60. In certain examples, the valve 200 selectively blocks the first flow path 191 and the second flow path 192 to thereby isolate the component of the marine drive or the marine vessel through which the second cooling fluid is circulated when the valve 200 is in the open position (FIGS. 4-7).

In order to move the valve 200 from the open position (FIGS. 4-7) to the closed position (FIGS. 8-11), the operator removes the fastener 261 from the arm hole 260 and the first hole 271 in the body 210. The operator then applies an axially directed force (see arrow F on FIG. 4) to the bracket 258 such that the second plunger ends 252 are moved axially toward the body 210. Once the arm hole 260 aligns with the second hole 272 in the body 210, the operator then inserts the fastener 261 into the arm hole 260 and the second hole 272 thereby locking the valve 200 in the closed position and the bracket 258 and the plungers 250 are in the retracted position, as depicted in FIGS. 8-11.

Moving the valve 200 into the closed position has several advantages. For example, when the marine drive 10 is manufactured, the first section 301 of the second cooling system 60 could filled with the second cooling fluid and shipped without spilling the second cooling fluid contained therein. When the marine drive 10 is received by the installer, the installer would first connect the second and third conduits 92, 93 to the valve 200 and then move the valve 200 into the open position thereby eliminating spillage of the second cooling fluid during installation of the marine drive 10. In another example, the marine drive 10 requires service and it is preferred to disconnect the second and third conduits 92, 93 from the valve 200 before servicing the marine drive 10. The operator moves the valve to the closed position and then can either drain the second cooling fluid in the second and third conduits 92, 93 via one or more drains 224, 244 and/or by disconnecting the second and third conduits 92, 93 from the valve 200 thereby reducing spillage of the second cooling fluid and retaining the second cooling fluid in the first section 301 of the second cooling section.

The drains 224, 244 allow for draining of the second cooling fluid from via the valve 200 when the valve 200 is in either the open position or the closed position. For example, with the valve 200 in the closed position, the operator of the valve 200 may wish to drain the second cooling fluid that is in the first section 301 of the second cooling system 60 and as such removes the drain covers 227, 247 that cover the drains 224, 244 that are in fluid communication with the passageway 220.

In another example, with the valve 200 in the closed position, the operator may wish to drain the cooling fluid from the second section 302 of the second cooling system 60 and as such removes the drain covers 227, 247 that cover the drains 224, 244 that are in fluid communication with the second passageway 240. Note that in this example, the first plunger sections 254 prevent flow of the second cooling fluid between the inlets 211, 231, respectively, and the outlets 215, 235 while the second plunger sections 255 (having a diameter smaller than the diameter of the first plunger sections 254) are in the channels 219, 239. As such, the second cooling fluid can flow around the second plunger section 255 to the drains 224, 244, respectively. In certain examples, a drain tube or conduit (not depicted) can be coupled to the drain 224, 244 to thereby permit the second cooling fluid to be drained from the second cooling system 60 away from the marine drive 10.

The valve 200 can moved from the closed position (FIGS. 8-11) to the open position (FIGS. 4-7) by removing the fastener 261 and applying an axially directed force in a second direction (see arrow E in FIG. 8) to the bracket 258 such that the second plunger ends 252 are moved axially away from the body 210. The operator then inserts the fastener 261 into the arm hole 260 and the first hole 271 in the body 210 thereby locking the valve 200 in the open position and the bracket 258 and the plungers 250 are in the extended positions, as depicted in FIGS. 4-7.

Note that while the bracket 258 is moved into and between the extend position and the retracted position, the leg 262 slides in and/or is guided by the track 273. The track 273 advantageously helps facilitate guiding the bracket 258 and preventing the plungers 250 from becoming misaligned as the valve 200 is moved into and between the open position and the closed position.

In certain independent examples, a marine drive includes a cooling system configured to circulate a cooling fluid to cool a component of the marine drive or a marine vessel, the cooling system includes a first flow path along which the cooling fluid is supplied to the component and a second flow path along which the cooling fluid is returned from the component. A valve is operable to block the first flow path and the second flow path to thereby prevent the circulation of the cooling fluid along the first flow path and the second flow path.

Optionally, the valve selectively blocks the first flow path and the second flow path to thereby isolate the component. Optionally, the valve is operable into an open position in which the valve is configured to permit the cooling fluid to be circulated along the first flow path and the second flow path. Optionally, the valve is operable into a closed position in which the valve is configured to block the first flow path and the second flow path such that the cooling fluid does not circulate through the first flow path and the second flow path. Optionally, the valve defines a first passageway through which the first flow path extends and a second passageway through which the second flow path extends, and the second passageway is independent from the first passageway. Optionally, the valve includes a first plunger selectively movable into the first flow path and a second plunger selectively movable into the second flow path to thereby prevent the circulation of the cooling fluid along the first flow path and the second flow path. Optionally, the valve includes a bracket coupled to the first plunger and the second plunger such that the first plunger, the second plunger, and the bracket are selectively moveable together. Optionally, the bracket, the first plunger, and the second plunger are movable together into an extended position such that the cooling fluid can be circulated along the first flow path and the second flow path and the bracket, the first plunger, and the second plunger are movable together into a retracted position in which the first plunger and the second plunger prevent the circulation of the cooling fluid along the first flow path and the second flow path. The valve further includes a body to which the bracket is selectively coupled to thereby lock the bracket, the first plunger, and the second plunger in the extended position or the retracted position. Optionally, the valve includes a flange with a first hole and a second hole and the bracket includes an arm with an arm hole. When the bracket is moved into a retracted position, the arm hole aligns with the second hole such that a fastener can be inserted through the arm hole and the second hole to lock the bracket in the retracted position. When the bracket is moved into an extended position, the arm hole aligns with the first hole such that the fastener can be inserted through the arm hole and the first hole to lock the bracket in the extended position. Optionally, the valve axially extends between a first end and a second end, and the first plunger and the second plunger are axially moved into the first flow path and the second flow path to prevent the circulation of the cooling fluid along the first flow path and the second flow path. Optionally, the valve includes a drain configured to permit draining of the cooling fluid from the first flow path or the second flow path. Optionally, the valve defines a first passageway through which the first flow path extends and a second passageway through which the second flow path extends and the drain is a first drain configured to permit draining of the cooling fluid from the first passageway. The valve further includes a second drain configured to permit draining of the cooling fluid from the second passageway. Optionally, the valve includes a first inlet and a first outlet through which the first flow path extends and a second inlet and a second outlet through which the second flow path extends. The first inlet and the second outlet extend parallel to a first axis, and the second inlet and the first outlet extend parallel to a second axis. The second axis is perpendicular to the first axis.

In certain independent examples, a valve includes a first passageway extending between a first inlet and a first outlet. The first inlet is configured to receive a cooling fluid from the marine drive such that the cooling fluid can be conveyed through the first passageway and dispensed via the first outlet to a component of the marine drive or a marine vessel. A second passageway extends between a second inlet and a second outlet, and the second inlet is configured to receive the cooling fluid from the component of the marine drive or the marine vessel such that the cooling fluid can be conveyed through the second passageway and dispensed from via the second outlet. A first plunger is selectively moveable to block the first passageway and a second plunger is selectively moveable to block the second passageway to thereby prevent circulation of the cooling fluid through the first passageway and the second passageway.

Optionally, the second passageway is independent from the first passageway. Optionally, the first inlet and the second outlet extend parallel to a first axis and the second inlet and the first outlet extend parallel to a second axis. The second axis is perpendicular to the first axis. Optionally, a first drain is configured to permit draining of the cooling fluid from the first passageway and a second drain configured to permit draining of the cooling fluid from the second passageway. The first drain and the second drain extend parallel to the second axis in a first direction, and the first outlet and the second inlet extend in an opposite second direction along the second axis. Optionally, a first drain is configured to permit draining of the cooling fluid from the first passageway and a second drain is configured to permit draining of the cooling fluid from the second passageway. Optionally, a bracket is coupled to the first plunger and the second plunger such that bracket, the first plunger, and the second plunger are movable together. Optionally, a track is configured to guide movement of the bracket.

Citations to a number of references are made herein. The cited references are incorporated by reference herein in their entireties. In the event that there is an inconsistency between a definition of a term in the specification as compared to a definition of the term in a cited reference, the term should be interpreted based on the definition in the specification.

In the present description, certain terms have been used for brevity, clarity, and understanding. No unnecessary limitations are to be inferred therefrom beyond the requirement of the prior art because such terms are used for descriptive purposes and are intended to be broadly construed. The different apparatuses, systems, and method steps described herein may be used alone or in combination with other apparatuses, systems, and methods. It is to be expected that various equivalents, alternatives, and modifications are possible within the scope of the appended claims.

This written description uses examples to disclose the invention and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A marine drive comprising:
a cooling system configured to circulate a cooling fluid to cool a component of the marine drive or a marine vessel, the cooling system includes a first flow path along which the cooling fluid is supplied to the component and a second flow path along which the cooling fluid is returned from the component; and
a valve operable to block the first flow path and the second flow path to thereby prevent the circulation of the cooling fluid along the first flow path and the second flow path.

2. The marine drive according to claim 1, wherein the valve selectively blocks the first flow path and the second flow path to thereby isolate the component.

3. The marine drive according to claim 1, wherein the valve is operable into an open position in which the valve is configured to permit the cooling fluid to be circulated along the first flow path and the second flow path.

4. The marine drive according to claim 1, wherein the valve is operable into a closed position in which the valve is configured to block the first flow path and the second flow path such that the cooling fluid does not circulate through the first flow path and the second flow path.

5. The marine drive according to claim 1, wherein the valve defines a first passageway through which the first flow path extends and a second passageway through which the second flow path extends, and wherein the second passageway is independent of the first passageway.

6. The marine drive according to claim 1, wherein the valve includes a first plunger selectively movable into the first flow path and a second plunger selectively movable into the second flow path to thereby prevent circulation of the cooling fluid along the first flow path and the second flow path.

7. The marine drive according to claim 6, wherein the valve includes a bracket coupled to the first plunger and the second plunger such that the first plunger, the second plunger, and the bracket are selectively moveable together.

8. The marine drive according to claim 7, wherein the bracket, the first plunger, and the second plunger are movable together into an extended position such that the cooling fluid can be circulated along the first flow path and the second flow path;
wherein the bracket, the first plunger, and the second plunger are movable together into a retracted position in which the first plunger and the second plunger prevent the circulation of the cooling fluid along the first flow path and the second flow path; and
wherein the valve further comprises a body to which the bracket is selectively coupled to thereby lock the bracket, the first plunger, and the second plunger in the extended position or the retracted position.

9. The marine drive according to claim 7, wherein the valve includes a flange with a first hole and a second hole and the bracket includes an arm with an arm hole; and
wherein when the bracket is moved into a retracted position, the arm hole aligns with the second hole such that a fastener can be inserted through the arm hole and the second hole to lock the bracket in the retracted position; and
wherein when the bracket is moved into an extended position, the arm hole aligns with the first hole such that the fastener can be inserted through the arm hole and the first hole to lock the bracket in the extended position.

10. The marine drive according to claim 6, wherein the valve axially extends between a first end and a second end, and wherein the first plunger and the second plunger are axially moved into the first flow path and the second flow path to prevent circulation of the cooling fluid along the first flow path and the second flow path.

11. The marine drive according to claim 1, wherein the valve includes a drain configured to permit draining of the cooling fluid from the first flow path or the second flow path.

12. The marine drive according to claim 11, wherein the valve defines a first passageway through which the first flow path extends and a second passageway through which the second flow path extends;
wherein the drain is a first drain configured to permit draining of the cooling fluid from the first passageway; and
wherein the valve further includes a second drain configured to permit draining of the cooling fluid from the second passageway.

13. The marine drive according to claim 1, wherein the valve includes a first inlet and a first outlet through which the first flow path extends and a second inlet and a second outlet through which the second flow path extends;
wherein the first inlet and the second outlet extend parallel to a first axis; and
wherein the second inlet and the first outlet extend parallel to a second axis, the second axis is perpendicular to the first axis.

14. A valve for a marine drive, the valve comprising:
a first passageway extending between a first inlet and a first outlet, wherein the first inlet is configured to receive a cooling fluid from the marine drive such that the cooling fluid can be conveyed through the first passageway and dispensed via the first outlet to a component of the marine drive or a marine vessel;
a second passageway extending between a second inlet and a second outlet, wherein the second inlet is configured to receive the cooling fluid from the component of the marine drive or the marine vessel such that the cooling fluid can be conveyed through the second passageway and dispensed from via the second outlet; and
a first plunger is selectively moveable to block the first passageway and a second plunger is selectively moveable to block the second passageway to thereby prevent circulation of the cooling fluid through the first passageway and the second passageway.

15. The valve according to claim 14, wherein the second passageway is independent of the first passageway.

16. The valve according to claim 14, wherein the first inlet and the second outlet extend parallel to a first axis; and
wherein the second inlet and the first outlet extend parallel to a second axis, the second axis is perpendicular to the first axis.

17. The valve according to claim 16, further comprising a first drain configured to permit draining of the cooling fluid from the first passageway and a second drain configured to permit draining of the cooling fluid from the second passageway; and
wherein the first drain and the second drain extend parallel to the second axis in a first direction and the first outlet and the second inlet extend in an opposite second direction along the second axis.

18. The valve according to claim 14, further comprising a first drain configured to permit draining of the cooling fluid from the first passageway and a second drain configured to permit draining of the cooling fluid from the second passageway.

19. The valve according to claim 14, further comprising a bracket coupled to the first plunger and the second plunger such that bracket, the first plunger, and the second plunger are movable together.

20. The valve according to claim 19, further comprising a track configured to guide movement of the bracket.
